(19) United States
(12) Patent Application Publication
(10) Pub. No.: US 2026/0121735 A1
(43) Pub. Date: Apr. 30, 2026

(54) WIRELESS NETWORK OPTIMISATION

(71) Applicant: SAGEMCOM BROADBAND SAS, BOIS-COLOMBES (FR)

(72) Inventors: Clément PARISOT, BOIS-COLOMBES (FR); Arthur JARDIN, BOIS-COLOMBES (FR)

(21) Appl. No.: 19/370,394

(22) Filed: Oct. 27, 2025

(30) Foreign Application Priority Data
Oct. 28, 2024 (FR) FR2411789

(51) Int. Cl. H04B 7/15; H04W 88/12

(52) U.S. Cl. CPC H04B 7/15; H04W 88/12

(57) ABSTRACT

Repeater apparatus arranged to receive from a primary access point a primary query comprising a request for information, with the aim of receiving primary information representative of a local radiofrequency environment of the repeater apparatus; transmit to each secondary station a secondary query comprising the request for information, and receive from each secondary station secondary information representative of a local radiofrequency environment of said secondary station; aggregate the secondary information with the primary information to produce aggregated information, and transmit the aggregated information to the primary access point.

### BACKGROUND OF THE INVENTION

The invention relates to the field of wireless communication networks, in particular Wi-Fi networks.

Apparatuses belonging to a wireless communication network may comprise one or more logical entities dedicated to communications, the two main categories being:
access points (AP): logical entities capable of providing wireless connectivity to other apparatuses so as to form a wireless network (defined, for example, as per the Wi-Fi standard);
stations: logical entities able to connect to the network of an access point.

As logical entities, access points and stations can be integrated in various apparatuses (e.g. in a telephone, a computer, a printer, a router, a home gateway, etc.).

With reference to FIG. 1, a home wireless network 1 thus conventionally comprises a home gateway 2 and an apparatus which will be referred to as a “repeater apparatus” 3.

The home gateway 2 is intended to interconnect a local area network (LAN) and a wide area network (WAN). The gateway 2 includes an access point 4, which will be referred to as the “primary access point” and which implements a wireless network 5, which will be referred to as the “primary wireless network”.

The gateway 2 controls the configuration of the physical layer (e.g. frequency, modulation) of the wireless connections between the apparatuses of the primary wireless network 5. The apparatuses 6 connected to the primary wireless network 5 are referred to here as “primary clients”. The term “client” means an apparatus comprising one or more stations that is able to connect to the network of an access point but does not include an access point. For example, clients can be a mobile phone (smartphone), a laptop, a tablet, a smart object (e.g. a watch, a bracelet, a ring, a sensor, a television, a smart speaker, etc.). The stations connected to the primary wireless network 5 of the primary access point 4 are referred to as “primary stations”. Each primary client 6 therefore comprises one or more primary stations 7.

The repeater apparatus 3, on the other hand, is an apparatus comprising both a station and one or more access points. The station of the repeater apparatus 3 can be connected to the network of the access point of another apparatus (here to the gateway 2), and its access points each have their own network to which the stations of other clients or repeater apparatuses can be connected. Here, the station of the repeater apparatus 3 is connected to the primary wireless network 5 and is therefore a primary station 7.

For the sake of simplicity, the repeater apparatus 3 is considered to comprise a single access point. The “secondary wireless network” 8 refers to the network formed by the access point of the repeater apparatus 3, the “secondary access point” refers to the access point 9 of the repeater apparatus 3, and the “secondary clients” refer to the clients 10 connected to the secondary wireless network 8 (only one client 10 is shown here). Each secondary client 10 therefore comprises a secondary station 11.

The repeater apparatus 3 may be:
a “conventional” repeater, i.e. a device for extending the coverage of the primary wireless network (i.e. the primary wireless network and the secondary wireless network are connected at IP level), or
a device that does not transfer data between the primary wireless network and the secondary wireless network, for example a set-top box (this may be an “enhanced” set-top box comprising, for example, one or more loudspeakers for playing back audio signals).

It is therefore understood that the primary wireless network 5 is implemented and managed by the primary access point 4 of the gateway 2 and that the primary station 7 of the repeater apparatus 3 is connected to the primary wireless network 5, just like the primary station 7 of the primary client 6. The secondary station 11 of the secondary client 10 is connected to the secondary wireless network 8 implemented and managed by the secondary access point 9 of the repeater apparatus 3.

It goes without saying that the configuration shown in FIG. 1 is an example configuration. The home wireless network 1 could be different. For example, one or more other primary clients 6 (or none) could be connected to the primary wireless network 5, one or more other secondary clients 10 could be connected to the secondary wireless network 8, and the repeater apparatus 3 could include a plurality of secondary access points 9 for implementing a plurality of secondary wireless networks 8, etc.

In general, a fundamental problem in the field of wireless communication technologies is optimising communication performance (e.g. throughput, latency, packet loss rate, etc.) by adjusting the configuration of the physical links to reduce the effects caused by interference at the physical layer. To be able to define the optimised configuration of the physical links, it is necessary to collect the data necessary to make this decision.

There are several standards and technologies which allow these relevant data to be collected from the stations of a network and which are used for managing wireless communication networks.

By way of example, the collection of these data is provided for in the following amendments to the standards defining the Wi-Fi communication protocol: IEEE 802.11h™ (2003) and IEEE 802.11k™ (2008). These amendments allow a Wi-Fi access point to query its stations to obtain various data, referred to as “statistical” data, which are representative of the communication quality in the wireless network. More specifically, these data are representative of the ability of the radiofrequency environment and the physical layer to enable greater or lesser communication performance across the wireless network.

These data include, for example, the RSSI (Received Signal Strength Indicator), scan results, channel occupation, etc., as observed by the station and gathered at the access point.

However, in this technology, only the primary stations 7 associated directly with the primary access point 4 can be used. The primary access point 4 cannot recover the data from the “hidden” stations, i.e. secondary stations 11 which are connected to the repeater apparatuses but are nevertheless part of the overall network 1. Thus, in the example of FIG. 1, the gateway 2 sending a query as per IEEE 802.11h™ or 802.11 k™ cannot probe the secondary station 11 of the apparatus 10 connected to the repeater apparatus 3.

Mesh-type Wi-Fi networks are those comprising a plurality of access points or repeater apparatuses and in which the access points and the repeater apparatuses coordinate in order to manage the set of networks (this set of networks corresponds to the home wireless network 1). For example, the Wi-Fi Easymesh standard, which is defined and certified by the organisation Wi-Fi Alliance and depends on the protocols defined in the IEEE 1905.1-2013 standard, allows a gateway to query the repeater apparatuses of the network to obtain information on all the apparatuses (including the stations connected to the networks of the access points of the repeater apparatuses).

However, this solution requires the support of the same mesh network technology in the primary access point (of the gateway) and in each of the repeater apparatuses. Thus, the access points and repeater apparatuses have to implement additional layers in order to manage the networks. However, this is not the case for many apparatuses (for example for the reference repeater EX6120). This solution is therefore restrictive because it requires additional software layers to be installed on the apparatuses.

There are also known gateways that implement communication performance optimisation methods, but all these gateways have at least one of the two above-mentioned limitations:
they do not allow the performance of “hidden” stations to be optimised because the primary access point does not have access to the necessary data from these hidden stations;
they require an additional layer/technology to be implemented within the repeater apparatuses and primary access points, meaning that this is not systematically supported.

It is also known that many repeater apparatuses are implemented with a single radio interface that is shared by all their access points and stations and therefore by all their networks, including the network of the access point to which they are connected. In the example of FIG. 1, the repeater apparatus 3 uses the same radio interface to connect to the primary wireless network 5 and the secondary wireless network 8. All the secondary networks of the repeater apparatus 3 therefore have to have the same configuration of the physical radio transmission layer (and therefore use, inter alia, the same frequency) because a radio interface can handle only one configuration of the physical layer at a time and because a radio interface cannot alternate between different configurations for two simultaneous networks. Since the primary access point 4 of the gateway 2 controls the configuration of its entire network, it is this configuration that has to be reused by all the other networks of the repeater apparatus. The repeater apparatus 3 therefore cannot modify the configuration of the physical layer of its secondary network 8 in order to optimise its performance. Only the primary access point 4 to which the repeater apparatus 3 is connected can carry out a reconfiguration of this kind, if needed. This is therefore another constraint to be taken into account, in addition to the two above-mentioned limitations.

### Object

The object of the invention is to allow a primary apparatus including a primary access point to optimise the communication performance in an overall wireless network that comprises a primary network implemented by said primary access point and a secondary network implemented by a secondary access point of a repeater apparatus:
by taking into account the local radiofrequency environments of the stations that are “hidden” for the primary access point;
without implementing any additional software layer in the primary access point;
without requiring a plurality of radio interfaces in the repeater apparatus.

### SUMMARY

To achieve this object, a repeater apparatus is proposed, which is arranged to be connected to a primary wireless network implemented by a primary access point, the repeater apparatus comprising a secondary access point arranged to implement a secondary wireless network to which at least one secondary station can be connected, the repeater apparatus being arranged to:
receive from the primary access point a primary query comprising a request for information, with the aim of receiving primary information representative of a local radiofrequency environment of the repeater apparatus;
transmit to each secondary station a secondary query comprising the request for information, and receive from each secondary station secondary information representative of a local radiofrequency environment of said secondary station;
aggregate the secondary information with the primary information to produce aggregated information, and transmit the aggregated information to the primary access point in response to the primary query.

The repeater apparatus retrieves and/or generates the primary information, receives the secondary information, produces the aggregated information, and thus transmits the aggregated information to the primary access point in response to the primary query. The primary apparatus, which includes the primary access point, e.g. a gateway, may use this aggregated information to optimise the communication performance in the primary wireless network and, more generally, in the overall wireless network comprising the primary wireless network and the secondary wireless network. In the event that the repeater apparatus comprises only one radio interface, the secondary access point of the repeater apparatus uses the same physical layer configuration as the primary access point, and the optimisations carried out by the primary apparatus also apply to the secondary wireless network. The primary apparatus performs this optimisation on the basis of the primary information but also on the basis of the secondary information, which is transmitted to it by being aggregated with the primary information. In optimising the transmissions in the primary wireless network, the primary apparatus actually also “unknowingly” takes account of the characteristics of the local radiofrequency environments of the secondary stations (information which the primary apparatus would normally not know) and therefore also optimises the transmissions in the secondary wireless network without this requiring an additional software layer in the primary access point.

The processing method for achieving this reconfiguration is carried out entirely in the repeater apparatus and is transparent to the primary apparatus.

In addition, a repeater apparatus as described above is proposed, in which the primary wireless network and the secondary wireless network are Wi-Fi networks.

In addition, a repeater apparatus as described above is proposed, comprising:
a single radio interface;
a primary station allowing the repeater apparatus to connect to the primary wireless network;
the primary station and the secondary access point using the single radio interface.

In addition, a repeater apparatus as described above is proposed, in which the information includes at least one parameter that is representative of a quality of a radiofrequency range for use by a wireless network.

In addition, a repeater apparatus as described above is proposed, in which the at least one parameter comprises:
a parameter that is representative, for a predefined period, of a fraction of said predefined period during which the radiofrequency channel is available for communicating, and/or
a parameter that is representative of a receive power of valid frames received, and/or
a parameter that is representative of a quantity of undecodable frames received, and/or
a parameter that is representative of beacon frames from access points other than the secondary access point of the repeater apparatus.

In addition, a repeater apparatus as described above is proposed, in which the primary query is a Clear Channel Assessment query.

In addition, a repeater apparatus as described above is proposed, in which at least one secondary station is integrated in an audio playback apparatus, and in which the information includes at least one parameter that is an operating parameter of an audio data string of said audio playback apparatus.

In addition, a repeater apparatus as described above is proposed, in which the at least one parameter includes a parameter that is representative of a padding of a buffer of the audio data string.

In addition, a repeater apparatus as described above is proposed, in which the information includes at least one parameter that is such that the higher its value, the higher the communication performance, the primary information including a primary value of said parameter, and the secondary information including secondary values of said parameter, the aggregated information including a minimum value of the primary value and of the secondary values.

In addition, a repeater apparatus as described above is proposed, in which the information includes at least one parameter that is such that the lower its value, the higher the communication performance, the primary information including a primary value of said parameter, and the secondary information including secondary values of said parameter, the aggregated information including a maximum value of the primary value and of the secondary values.

In addition, a repeater apparatus as described above is proposed, the repeater apparatus being a set-top box.

In addition, a processing method is proposed, which is carried out in the repeater apparatus as described above and comprises the steps of:
receiving from the primary access point a primary query comprising a request for information, with the aim of receiving primary information representative of a local radiofrequency environment of the repeater apparatus;
transmitting to each secondary station a secondary query comprising the request for information, and receiving from each secondary station secondary information representative of a local radiofrequency environment of said secondary station;
aggregating the secondary information with the primary information to produce aggregated information and transmitting the aggregated information to the primary access point in response to the primary query.

In addition, a computer program is proposed, comprising instructions which cause the repeater apparatus as described above to execute the steps of the processing method as described above.

In addition, a computer-readable storage medium is proposed, on which the computer program as described above is stored.

In addition, a system for configuring an overall wireless network is proposed, the configuration system comprising a repeater apparatus as described above, the secondary access point of which is arranged to implement the secondary wireless network, and a primary apparatus comprising the primary access point, which is arranged to implement the primary wireless network, the overall wireless network encompassing the primary wireless network and the secondary wireless network, the primary apparatus being arranged to:
transmit the primary query to the repeater apparatus;
receive the aggregated information in response to the primary query;
reconfigure the overall wireless network on the basis of the aggregated information in order to optimise the communication performance in the overall wireless network, the reconfiguration using a reconfiguration method that is initially intended to be carried out using the primary information, the reconfiguration method not being modified but being carried out using the aggregated information instead of the primary information.

In addition, a configuration system as described above is proposed, in which, to reconfigure the overall wireless network, the primary apparatus is arranged to modify a frequency or a radiofrequency channel used in the primary wireless network.

In addition, a reconfiguration method is proposed, which is carried out in the primary apparatus of the configuration system as described above and comprises the steps of:
transmitting the primary query to the repeater apparatus;
receiving the aggregated information;
reconfiguring the overall wireless network on the basis of the aggregated information in order to optimise the communication performance in the overall wireless network, the reconfiguration using a reconfiguration method that is initially intended to be carried out using the primary information, the reconfiguration method not being modified but being carried out using the aggregated information instead of the primary information.

In addition, a computer program is proposed, comprising instructions which cause the primary apparatus of the configuration system as described above to execute the steps of the reconfiguration method as described above.

In addition, a computer-readable storage medium is proposed, on which the computer program as described above is stored.

The invention will be better understood in the light of the following description of a particular, non-limiting embodiment of the invention.

### BRIEF DESCRIPTION OF THE DRAWINGS

Reference will be made to the accompanying drawings, in which:

FIG. 1 shows a prior-art home wireless network;

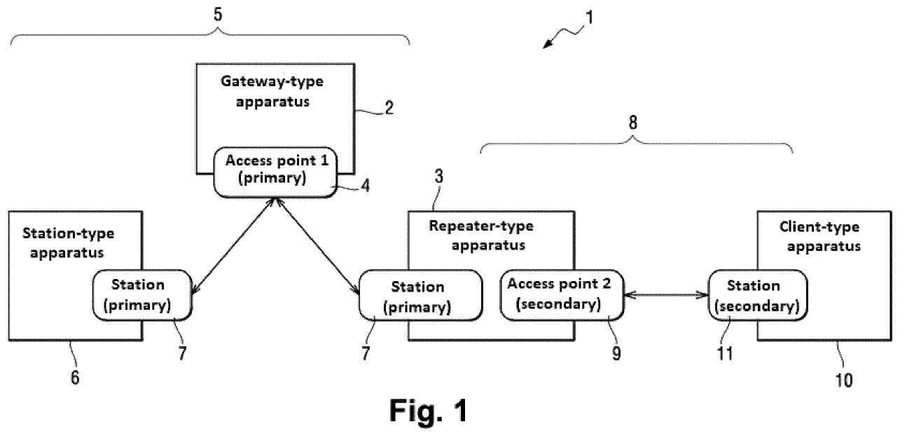

FIG. 2 shows a repeater apparatus, a gateway and two secondary clients;

FIG. 3 is a figure similar to FIG. 2, further showing the exchanges of queries among said apparatuses;

FIG. 4 is a diagram showing the interactions between the gateway, the repeater apparatus and a secondary client;

FIG. 5 is a diagram showing the steps of the processing method carried out in the repeater apparatus;

FIG. 6 is a diagram showing the steps of the reconfiguration method carried out in the gateway.

### DETAILED DESCRIPTION

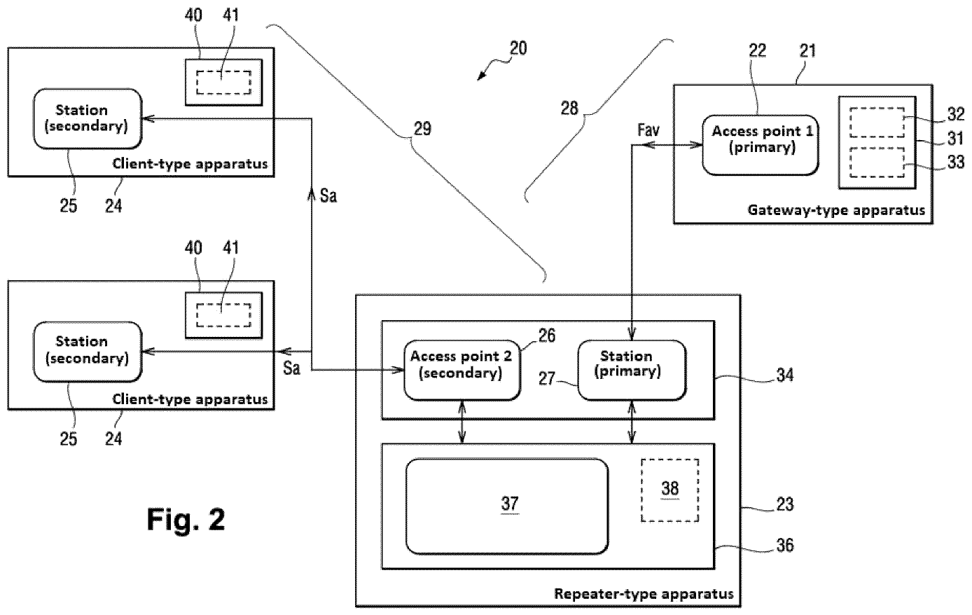

With reference to FIG. 2, the home wireless network 20 comprises:
a primary apparatus 21 comprising a primary access point 22;
a repeater apparatus 23;
secondary clients 24, each of which comprises a secondary station 25.

The definitions provided in the “Background of the invention” section of the present description also apply to the description of the invention.

Thus, the repeater apparatus 23 comprises at least one secondary access point 26 and a primary station 27. The primary station 27 allows the repeater apparatus 23 to be connected to the primary wireless network 28 implemented by the primary access point 22 of the primary apparatus 21. The secondary access point 26 implements a secondary wireless network 29 to which the secondary clients 24 are each connected by means of their secondary station 25.

In a particular embodiment described herein:
the primary apparatus 21 is a home gateway;
the repeater apparatus 23 is a set-top box, and in this case an enhanced set-top box comprising loudspeakers, and is therefore arranged to play back audio signals itself;
the secondary clients 24 are audio playback apparatuses, in this case satellite speakers (smart speakers).

The set-top box 23 broadcasts an audio-video stream Fav, which may come from the gateway 21, and transmits the audio signals Sa to its own loudspeakers as well as to the smart speakers 24 to implement multi-channel playback. It goes without saying that other data also flow in both directions between these different apparatuses.

The primary wireless network 28 and the secondary wireless network 29 are Wi-Fi networks here.

In addition to the primary access point 22, the gateway 21 comprises a processing unit 31. The processing unit 31 is an electronic and software unit. The processing unit 31 comprises at least one processing component 32, which is, for example, a “general-purpose” processor, a processor specialising in signal processing (digital signal processor, DSP), a processor specialising in artificial intelligence algorithms (neural processing unit, NPU), a microcontroller, or a programmable logic circuit, such as an FPGA (field-programmable gate array) or an ASIC (application-specific integrated circuit).

The processing unit 31 also comprises one or more memories 33, connected to or integrated in the one or more processing components 32. At least one of these memories 33 forms a computer-readable storage medium on which at least one computer program is stored, said computer program comprising instructions which cause the processing unit 31 to execute the steps of the reconfiguration method which will be described below.

It should be noted here that the processing unit 31 is not necessarily completely separate from the primary access point 22. These entities may share at least one hardware and/or software module.

As set out above, the set-top box 23 comprises the secondary access point 26 and the secondary station 27. The set-top box 23 comprises a single radio interface 34, i.e. a single radiofrequency transmission chain, which here is integrated in a single wireless communication chipset.

The secondary access point 26 and the primary station 27 of the set-top box 23 both use this single radio interface 34 to communicate within the primary wireless network 28 and within the secondary wireless network 29.

In turn, the set-top box 23 also comprises a processing unit 36. The processing unit 36 is an electronic and software unit. The processing unit 36 comprises at least one processing component 37, which is, for example, a “general-purpose” processor, a processor specialising in signal processing (digital signal processor, DSP), a processor specialising in artificial intelligence algorithms (neural processing unit, NPU), a microcontroller, or a programmable logic circuit, such as an FPGA (field-programmable gate array) or an ASIC (application-specific integrated circuit).

The processing unit 36 also comprises one or more memories 38, connected to or integrated in the one or more processing components. At least one of these memories 38 forms a computer-readable storage medium on which at least one computer program is stored, said computer program comprising instructions which cause the processing unit 36 to execute the steps of the processing method which will be described below.

The processing unit 36 comprises a Wi-Fi driver, possibly integrated in the one or more processing components 37.

It should be noted here that the processing unit 36 is not necessarily completely separate from the secondary access point 26 and the primary gateway 27. These entities may share at least one hardware and/or software module.

It is possible that one of the satellite speakers 24 connected to the secondary access point 26 of the set-top box 23 is close to a source of interference. The communication performance between this speaker 24 and the set-top box 23 is poor because of this source of interference, which can impair the playback of the audio signals Sa.

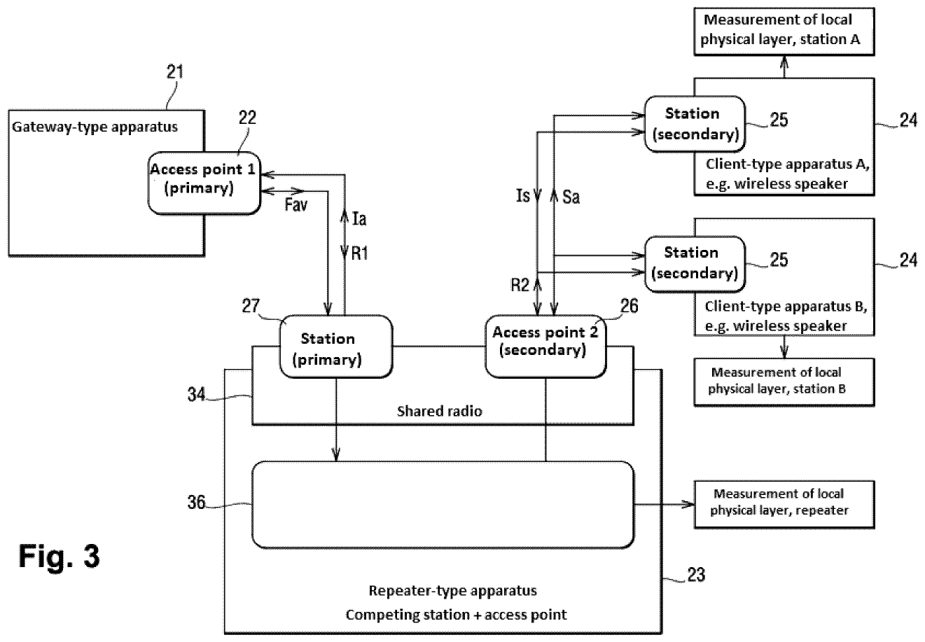

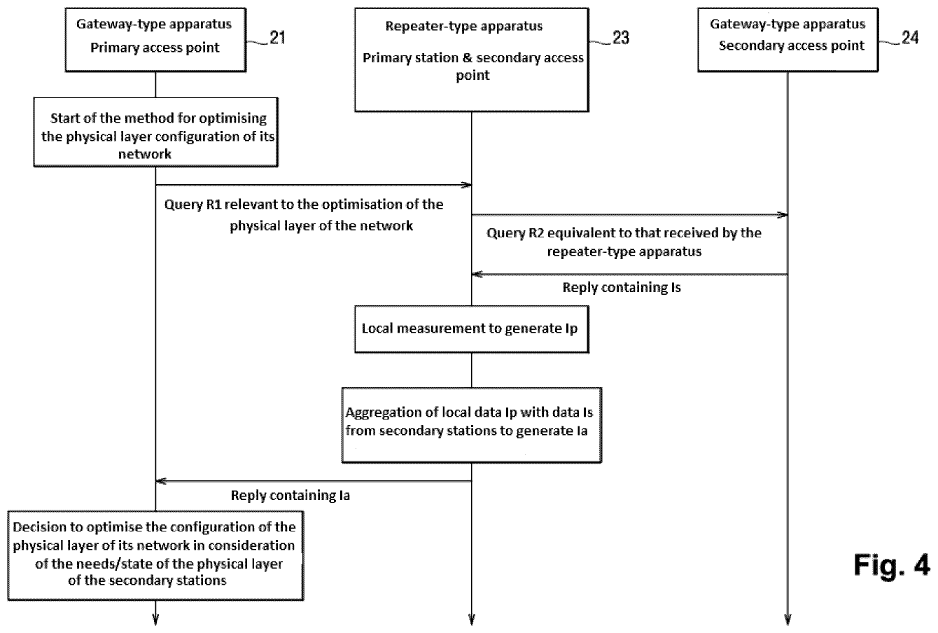

With reference to FIGS. 3 and 4, it will now be described how these various apparatuses interact to optimise the wireless communication performance in the home wireless network 20 encompassing the primary wireless network 28 and the secondary wireless network 29. This optimisation will in particular allow the above-mentioned interference problem to be improved.

The gateway 21 carries out a reconfiguration method, which is initially aimed at optimising the physical layer and the communication performance in the primary network 28 but which will actually optimise the communication performance throughout the network 20.

The gateway 21 transmits E20 a primary query R1 to the set-top box 23, which receives said query by means of its primary station 27. This primary query R1 contains a request for information, with a view to receiving primary information representative only of the local radiofrequency environment of the set-top box 23 (not of the local radiofrequency environment of the secondary stations 25 since the gateway 21 is not configured to query them).

This primary query R1 is a conventional query, defined as per the IEEE 802.11h™ or IEEE 802.11k™ standard, which allows the gateway 21 to query the primary stations 27 linked directly to its primary access point 22 so as to receive data that will allow the gateway 21 to adjust the configuration of the physical links to reduce the effects caused by interference at the physical layer.

The set-top box 23 receives the primary query R1 at level 2 of the OSI model (i.e. the link layer).

The set-top box 23 then processes this request for information and therefore produces the primary information Ip concerning its own local radiofrequency environment (by carrying out measurements, for example), but it also transmits a secondary query R2 comprising the request for information to each secondary station 25 of its secondary wireless network 29.

The secondary query R2 may differ from the primary query R1 but contains the same request for information. The secondary query R2 is a query equivalent to the “original” primary query R1. The secondary query R2 is based on the primary query R1 and can be interpreted by the secondary stations 25. In the case of a Wi-Fi network, for example, the equivalent secondary queries R2 sent to the secondary stations are the same IEEE 802.11k™ query as the original primary query but merely with the values of the query fields adapted as necessary.

From each secondary station 25, the set-top box 23 receives secondary information Is produced by said secondary station 25, this information thus being representative of the local radiofrequency environment of said secondary station.

Then, the set-top box 23 aggregates the secondary information Is with the primary information Ip that it has produced, to produce aggregated information Ia, and transmits the aggregated information Ia to the gateway 21. It can thus be seen in FIG. 3 that new data R1, R2, Is, Ia flow between the apparatuses. The aggregated information Ia replaces the primary information Ip but is in the same format.

The aggregation of the secondary information Is with the primary information Ip is therefore not a mere concatenation of two distinct fields in the same frame (one field for the primary information Ip and one field for the secondary information Is). Rather, it is the combination of the primary information Ip and the secondary information Is in one and the same field which normally contains only the primary information Ip but here contains the aggregated information Ia.

The information requested by the gateway 21 may relate to different parameters that are representative of the quality of the communications in the network.

By way of example, the information includes at least one parameter that is representative of a quality of a radiofrequency range for use by a wireless network. Said at least one parameter is, for example, representative of disturbances and/or interference over the radiofrequency range.

The parameters thus comprise, for example, a parameter that is representative, for a predefined period, of a fraction of said period during which a radiofrequency channel is available for communicating.

By way of example, the primary query R1 sent by the gateway 21 is then in the IEEE 802.11h™ or IEEE 802.11 k™ standard, a Clear Channel Assessment (CCA) query that contains the following fields:
Channel Number: the number representing the frequency range over which the apparatus receiving the primary query has to measure the quality of the radiofrequency environment;
Measurement Start Time: the value of a periodic counter of the primary access point sending the primary query, for indicating when the measurement should start. The value of this counter is independently shared with the apparatus receiving the query and is generally used for time synchronisation between an access point and its stations;
Measurement Duration: the period during which the measurement has to be taken.

In this case, the set-top box 23 sends an equivalent secondary query R2 of the Clear Channel Assessment type to the secondary stations 25 that have declared that they support such a query (during the step of linking an access point and a station, the station indicates to the access point whether it supports the processing of the query R1):
with the same value in the Channel Number and Measurement Duration fields;
with a value of the periodic counter of the secondary access point of the set-top box in the Measurement Start Time field corresponding to the same time for the start of the measurement as that indicated in the primary query. The periodic counter of the access point 26 of the set-top box 23 is generally not synchronised with the periodic counter of the primary access point 22 of the gateway 21, and so the same time is not represented by the same value in the counters of each apparatus.

The values of the fields of the secondary queries R2 sent by the set-top box 23 are therefore not identical to those in the primary query R1 but do represent the same data request.

In response to the secondary query R2, the secondary stations 25 provide a reply message including relevant statistical data, such as the CCA Busy Fraction value for “CCA Report” or the Channel Load value for “Channel Load Report” which indicates the fraction of time that is actually available for communicating because there is no interference on the radio channel. Each piece of data sent indicates the quality and state of the physical layer, which in particular depends on the disturbances, in a different way. These data therefore allow the presence of disturbances to be indicated and evaluated.

The Clear Channel Assessment query is one example of a query that can be used, but it is not the only one.

As set out above, the requested information may relate to a parameter other than a parameter that is representative of the availability of a radiofrequency channel for sending frames.

The parameters used may include a parameter that is representative of a quantity of valid frames received.

The query is then, for example, a Receive Power Indicator (RPI) Histogram query. This query makes it possible to obtain a histogram indicating the quantity of Wi-Fi frames received in different receive power intervals.

The parameters used may include a parameter that is representative of a quantity of undecodable frames received.

The query is then, for example, a Noise Histogram query. This query makes it possible to obtain a (power) histogram of the received signals that could not be decoded into Wi-Fi frames, on a particular channel (the signal received is considered to be noise).

The parameters used may include a parameter that is representative of received beacon frames from access points other than the secondary access point 26 of the set-top box 23.

The query is then, for example, a Beacon query, which makes it possible to obtain information that other access points announce about themselves, as observed by a station.

The parameters used may include a parameter that is representative of the communication performance.

The query is then, for example, an STA Statistics query, which requests various performance-related statistics (e.g. the quantities of Retry, Transmitted, Received, RTS Success, RTS Failure, Access Delay).

The parameters used may include a parameter that is representative of the quality of the connections between the secondary access point 26 of the set-top box 23 and the secondary stations 25. For Wi-Fi networks, for example, these are a packet loss or packet retry percentage (% packet lost/retry), a histogram of the Modulation Coding Scheme (MCS) used, which provides information on the quality of the Wi-Fi communication, and jitter, etc. It should be noted that these data are not requested in parameters of queries sent by the gateway 21. The set-top box 23 retrieves these data internally when it receives a query for other types of information. The set-top box 23 uses these data as inputs to the aggregation algorithm.

Here, as set out above, the repeater apparatus 23 is a set-top box, and the secondary stations 25 are integrated in the satellite speakers 24.

The set-top box 23 transmits audio signals Sa to the speakers 24 to be played back.

The parameters used may include an operating parameter of the audio data string 40 of the satellite speakers 24. For a speaker 24, the “audio data string” 40 comprises the hardware and software functions between the receipt of the audio signals emitted by the set-top box 23 and the one or more loudspeakers of said speaker 24.

By way of example, this parameter is representative of the padding of the audio buffers 41 of the speakers 24. This is, for example, the histogram of the health of audio buffers. The padding of the audio buffers 41 is representative of the transmission quality between the audio signal sources and the receivers, meaning that it can be used to characterise the communication performance.

Functional reliability measurements are therefore used. The function is the emitting of sound by the satellite speakers 24, the measure of its reliability is the measurement of the number of audio cuts, and each instance of empty audio buffer 41 is a potential audio cut. It is therefore a way of measuring the performance of the network link between the set-top box 23 and the satellite speakers 24.

It should be noted that if the set-top box 23 does not include a loudspeaker and therefore does not contain an audio data string, it is not possible to calculate this parameter for the set-top box 23, which potentially poses a problem for aggregating the secondary information Is with the primary information Ip. In this case, as the primary information Ip for producing the aggregated information Ia, the processing unit 36 of the set-top box 23 uses a predefined value for said parameter, which, for example, is zero.

It should be noted that the above may be true for parameters other than operating parameters of an audio data string.

As set out above, from each secondary station 25 the set-top box 23 thus receives secondary information Is produced by said secondary station 25, this information being representative of the local radiofrequency environment of said secondary station 25. The set-top box 23 then aggregates the secondary information Is with the primary information Ip that it has produced itself, to produce aggregated information Ia, and transmits the aggregated information Ia to the gateway 21.

The aggregated information Ia has the same format as the primary information Ip that would have been produced by the set-top box 23 if it had not queried the secondary stations 25. The aggregated information Ia is derived from a combination of the primary information Ip and the secondary information Is, meaning that the origin of said information can no longer be discerned. The aggregated information Ia is therefore representative of both the local radiofrequency environment of the set-top box 23 and of the local radiofrequency environments of the speakers 24 that are connected to the secondary access point 26 of the set-top box 23 by means of their secondary station 25.

The aggregation may be performed in different ways and depends on the parameter requested.

The requested information can include at least one parameter that is such that the higher its value, the higher the communication performance (i.e. the higher the quality of the physical layer). The primary information Ip includes a primary value of said parameter, and the secondary information Is includes secondary values of said parameter (one for each secondary station). The aggregated information Ia then includes, for example, a minimum value of the primary value and of the secondary values.

This relates, for example, to the Receive Power Indicator Histogram query. Therefore, the parameter is, for example, representative of the receive power of valid frames received.

The requested information may include at least one parameter that is such that the lower its value, the higher the communication performance. The primary information Ip includes a primary value of said parameter, and the secondary information Is includes secondary values of said parameter (one for each secondary station). The aggregated information Ia then includes, for example, a maximum value of the primary value and of the secondary values.

This relates, for example, to Clear Channel Assessment, Channel Load or Noise Histogram queries. Therefore, the parameter is, for example, representative of the availability of a communication channel for sending frames, of a quantity of undecodable frames received, or of the power of the received signals that could not be decoded into frames.

The set-top box 23 then transmits the aggregated information to the gateway 21.

The gateway 21 therefore receives E21 the reply to its primary query R1 in the form of aggregated information Ia. The gateway 21 sent the primary query R1 to collect data/information/statistics in order to decide on a reconfiguration of the networks of its access points 22 that improves/optimises the network performance. Consequently, once the gateway 21 has received all the replies to all the primary queries R1 it sent, it launches the reconfiguration method E22 depending on the information gathered. In particular, the method makes it possible to correct the problems in the network in order to improve the overall communication performance. The reconfiguration uses a reconfiguration method that is initially intended to be carried out using the primary information, the reconfiguration method not being modified but being carried out using the aggregated information instead of the primary information.

Owing to the aggregated information gathered by the set-top box 23, the gateway 21 detects any local interference or disturbances at the secondary stations 25 affecting the performance of the wireless network 20 for those secondary stations. The gateway 21 is able to take such a decision (to reconfigure the networks it manages) that this interference no longer causes a problem.

For example, the decision of the gateway 21 may be to change the frequency or radiofrequency channel used by its network if interference or disturbances are detected (locally or through queries sent to other apparatuses) in the radiofrequency channel currently being used. If the gateway 21 (in the reply to a query, sent by it to a repeater or a client, for information on the quality of the local radiofrequency environment) receives data indicating that there is interference on the radiofrequency channel currently being used by its network, the gateway 21 chooses another radiofrequency channel that does not contain the problematic frequency.

The new frequency or new channel can be selected at random or by retrieving information on other potential frequencies or channels in order to compare the quality of the radiofrequency environment with the different frequency ranges.

For example, if the gateway 21 is informed, via the various queries sent to (inter alia) a repeater apparatus connected to its network (such as the set-top box 23), that there are many disturbances on the radiofrequency channel currently being used (by it and therefore also by the set-top box 23 and the secondary stations 25 of the set-top box 23) but few disturbances on another available radiofrequency channel, it may decide to change channel to ensure that it operates on this other channel.

Owing to this decision by the gateway 21, the secondary stations 25 are no longer subject to the local interference effects, and their performance is improved. This is possible owing to the set-top box 23, which indirectly informed the gateway 21 of the interference in question.

In the present example, the detection of radiofrequency disturbances has been considered. However, other disruptive conditions that may cause a drop in communication performance may be detected on the basis of the information collected from the secondary stations 25.

As set out above, the set-top box 23 is arranged to transfer a secondary query R2, equivalent to the primary query R1, to the secondary stations 25. The set-top box 23 is furthermore arranged to aggregate the data collected from the secondary stations 25 in response to the transferred query R2, the aggregated information Ia then being transmitted to the gateway 21.

It follows that one of the advantages of the invention over the prior art is that the relevance of the data taken into account by the gateway 21 for configuring the network is improved. In particular, the local information of the secondary stations 25 collected owing to the transfer of the query performed by the set-top box 23 makes it possible to inform the gateway 21 about potential limitations that might not have been detected in the prior art (for example, the presence of disturbances, the causes of limitations in the communication performance of the network, etc.). Moreover, aggregating the data further increases the relevance of the data that are gathered at the gateway 21 to (re)configure the network. Owing to the data being more relevant, the gateway 21 can better optimise the configuration of the set of networks by optimising the one or more secondary wireless networks 29 by changing the configuration of the primary network, which was not the case in the prior art. Thus, the improvement provided by the invention is evident specifically within the gateway 21, which, owing to more relevant data, can take decisions that take better account of the actual conditions in the network as a whole and can thus best adapt the configuration of the network. The result of improving the network configuration is that the communication performance of all or part of the network can be improved in real time. However, the invention does not modify the network management method as such, conventionally carried out within the gateway 21. The data input therein are merely more relevant and complete.

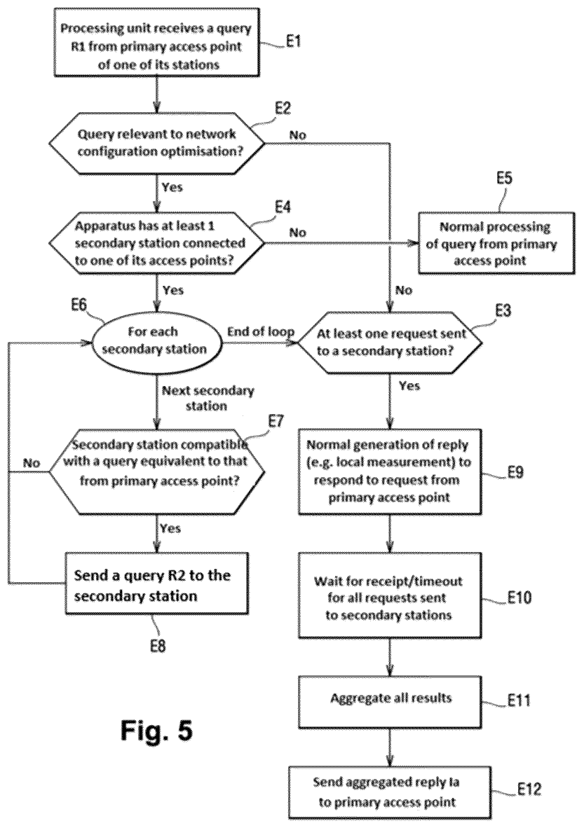

Now, with reference to FIG. 5, the different steps of the processing method that are carried out by the processing unit 36 of the set-top box 23 will be described in a synoptic manner.

By means of its primary station 27, the set-top box 23 receives a primary query R1 from the primary access point 22 of the gateway 21. The query is transmitted to the processing unit 36: step E1.

The processing unit 36 of the set-top box 23 checks whether this query concerns the optimisation of the network configuration: step E2.

If it does not, the method moves on to step E5: processing the primary query normally.

If it does, the processing unit 36 checks whether the set-top box 23 has at least one secondary station 25 connected to its secondary access point 26: step E4.

If it does not, the set-top box 23 moves on to step E5. The set-top box 23 does not transmit a secondary query or receive secondary information. The processing unit 36 controls the operations (local measurements, for example) to produce the primary information Ip relating to the local radiofrequency environment of the set-top box 23 and then sends this primary information Ip to the gateway 21. This is equivalent to the usual operation of a repeater apparatus not comprising the invention.

In step E4, if the set-top box 23 does have at least one secondary station 25 connected to its secondary access point 26, a transmission loop to the secondary stations begins: step E6.

For the first secondary station 25, the processing unit 36 checks whether this station 25 is compatible with a secondary query equivalent to the primary query: step E7.

If it is not compatible, the method returns to step E6, and the secondary station 25 is processed.

If it is compatible, the set-top box 23 sends a secondary query R2 to the secondary station 25 (step E8), and the method returns to step E6: the next secondary station 25 is processed.

When the loop is complete, i.e. when the secondary queries R2 have been transmitted to all the compatible secondary stations 25, the method moves on to step E3.

In this step E3, the processing unit 36 checks whether at least one secondary query R2 has been sent to a secondary station 25.

If it has, the processing unit 36 controls the operations (local measurements, for example) to produce the primary information Ip relating to the local radiofrequency environment of the set-top box: step E9.

The processing unit 36 waits for the receipt (or timeout) for all the queries sent to the secondary stations 25: step E10.

Then, the processing unit 36 aggregates the primary information Ip produced by the set-top box 23 and all the secondary information Is produced by all the relevant secondary stations 25, to produce the aggregated information Ia: step E11.

The processing unit 36 then transmits the aggregated information Ia to the primary access point 22 of the gateway 21: step E12.

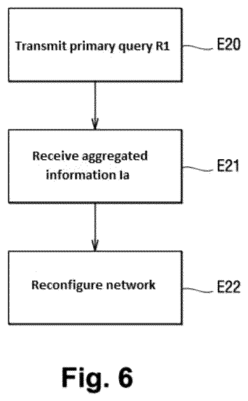

Now, with reference to FIG. 6, the different steps of the reconfiguration method that are carried out by the processing unit 32 of the gateway 21 will be described in a synoptic manner.

The processing unit 32 uses the primary access point 22 to transmit the primary query R1 to the set-top box 23: step E20.

Then, the processing unit 32 receives the aggregated information Ia by means of the primary access point 22: step E21.

The processing unit 32 then reconfigures the primary wireless network 28, and thus the overall wireless network 20, on the basis of the aggregated information in order to optimise the communication performance in the overall wireless network 20: step E22.

Thus, as soon as the aggregated information is gathered at the gateway 21 by the repeater apparatus 23, the gateway 21 analyses these data by comparing them with predetermined thresholds. For example, if the values are greater than a reference threshold, the gateway 21 considers these values to be representative of interference. These thresholds may be proprietary (and are therefore dependent on the implementation and the manufacturer of the gateway).

It is important to note that the invention does not require any new query types to be defined in the communication protocol standards in order to remain compatible with existing products and thus to be as interoperable as possible.

It goes without saying that the invention is not limited to the described embodiment but covers any variant falling under the scope of the invention as defined by the claims.

The repeater apparatus is not necessarily a set-top box comprising loudspeakers. It could be a set-top box without a loudspeaker and, more generally, any apparatus comprising at least one access point and one station. The primary access point is not necessarily integrated in a home gateway.

Audio playback apparatuses are not necessarily satellite speakers; they could be, for example, a sound bar, a hi-fi amplifier, etc. Secondary clients are not necessarily audio playback apparatuses.

The architectures of the apparatuses could be different from those described here.

1. A repeater apparatus arranged to be connected to a primary wireless network implemented by a primary access point, the repeater apparatus comprising a secondary access point arranged to implement a secondary wireless network to which at least one secondary station can be connected, the repeater apparatus being arranged to:
receive from the primary access point a primary query comprising a request for information, with the aim of receiving primary information representative of a local radiofrequency environment of the repeater apparatus;
transmit to each secondary station a secondary query comprising the request for information, and receive from each secondary station secondary information representative of a local radiofrequency environment of said secondary station;
aggregate the secondary information with the primary information to produce aggregated information, and transmit the aggregated information to the primary access point in response to the primary query.

2. The repeater apparatus according to claim 1, wherein the primary wireless network and the secondary wireless network are Wi-Fi networks.

3. The repeater apparatus according to claim 1, comprising:
a single radio interface;
a primary station allowing the repeater apparatus to connect to the primary wireless network;
the primary station and the secondary access point using the single radio interface.

4. The repeater apparatus according to claim 1, wherein the information includes at least one parameter that is representative of a quality of a radiofrequency range for use by a wireless network.

5. The repeater apparatus according to claim 4, wherein the at least one parameter comprises:
a parameter that is representative, for a predefined period, of a fraction of said predefined period during which the radiofrequency channel is available for communicating, and/or
a parameter that is representative of a receive power of valid frames received, and/or
a parameter that is representative of a quantity of undecodable frames received, and/or
a parameter that is representative of beacon frames from access points other than the secondary access point of the repeater apparatus.

6. The repeater apparatus according to claim 5, wherein the primary wireless network and the secondary wireless network are Wi-Fi networks and wherein the primary query is a Clear Channel Assessment query.

7. The repeater apparatus according to claim 1, wherein at least one secondary station is integrated in an audio playback apparatus, and wherein the information includes at least one parameter that is an operating parameter of an audio data string of said audio playback apparatus.

8. The repeater apparatus according to claim 7, wherein the at least one parameter includes a parameter that is representative of a padding of a buffer of the audio data string.

9. The repeater apparatus according to claim 1, wherein the information includes at least one parameter that is such that the higher its value, the higher the communication performance, the primary information including a primary value of said parameter, and the secondary information including secondary values of said parameter, the aggregated information including a minimum value of the primary value and of the secondary values.

10. The repeater apparatus according to claim 1, wherein the information includes at least one parameter that is such that the lower its value, the higher the communication performance, the primary information including a primary value of said parameter, and the secondary information including secondary values of said parameter, the aggregated information including a maximum value of the primary value and of the secondary values.

11. The repeater apparatus according to claim 1, the apparatus being a set-top box.

12. A processing method carried out in a repeater apparatus according to claim 1 and comprising the steps of:
receiving from the primary access point a primary query comprising a request for information, with the aim of receiving primary information representative of a local radiofrequency environment of the repeater apparatus;
transmitting to each secondary station a secondary query comprising the request for information, and receiving from each secondary station secondary information representative of a local radiofrequency environment of said secondary station;
aggregating the secondary information with the primary information to produce aggregated information and transmitting the aggregated information to the primary access point in response to the primary query.

13. A computer program comprising program code instructions for executing the steps of the processing method according to claim 12 when said program is executed on a computer.

14. A computer-readable storage medium on which the computer program according to claim 13 is stored.

15. A system for configuring an overall wireless network, the configuration system comprising a repeater apparatus according to claim 1, to the secondary access point of which is arranged to implement the secondary wireless network, and a primary apparatus comprising the primary access point, which is arranged to implement the primary wireless network, the overall wireless network encompassing the primary wireless network and the secondary wireless network, the primary apparatus being arranged to:
transmit the primary query to the repeater apparatus;
receive the aggregated information in response to the primary query;
reconfigure the overall wireless network on the basis of the aggregated information in order to optimise the communication performance in the overall wireless network, the reconfiguration using a reconfiguration method that is initially intended to be carried out using the primary information, the reconfiguration method not being modified but being carried out using the aggregated information instead of the primary information.

16. The system according to claim 15, wherein, to reconfigure the overall wireless network, the primary apparatus is arranged to modify a frequency or a radiofrequency channel used in the primary wireless network.

17. A reconfiguration method carried out in the primary apparatus of the configuration system according to claim 15 and comprising the steps of:
transmitting the primary query to the repeater apparatus;
receiving the aggregated information;
reconfiguring the overall wireless network on the basis of the aggregated information in order to optimise the communication performance in the overall wireless network, the reconfiguration using a reconfiguration method that is initially intended to be carried out using the primary information, the reconfiguration method not being modified but being carried out using the aggregated information instead of the primary information.

18. A computer program comprising program code instructions for executing the steps of the reconfiguration method according to claim 17 when said program is executed on a computer.

19. A computer-readable storage medium on which the computer program according to claim 18 is stored.

20. The repeater apparatus according to claim 5, wherein the primary query is a Clear Channel Assessment query.
